(19) United States
(12) Patent Application Publication
(10) Pub. No.: US 2024/0340124 A1
(43) Pub. Date: Oct. 10, 2024

(54) OPTIMIZATION OF SOUNDING REFERENCE SIGNAL ANTENNA SWITCHING CONFIGURATION

(71) Applicant: T-Mobile Innovations LLC, Overland Park, KS (US)

(72) Inventors: Christopher BAILEY, Overland Park, KS (US); Ryan DREILING, Shawnee, KS (US)

(21) Appl. No.: 18/295,420

(22) Filed: Apr. 4, 2023

(51) Int. Cl. H04L 5/00; H04B 1/00

(52) U.S. Cl. CPC H04L 5/0023; H04B 1/0064; H04L 5/0035; H04L 5/0048

(57) ABSTRACT

Methods provided herein include receiving, at a user equipment (UE) a UE capability enquiry from a radio access network (RAN). The UE has an original antenna configuration and is capable of new radio carrier aggregation (NRCA). Methods include sending from the UE to the RAN, in response to the UE capability enquiry, a UE capability information message. The UE capability information message indicates an optimized SRS antenna switching configuration that is different from the original antenna configuration.

### TECHNICAL BACKGROUND

As wireless networks evolve and grow, there are ongoing challenges in communicating data across different types of networks. For example, a wireless network may include one or more access nodes, such as base stations, for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 4G long-term evolution (LTE) access nodes.

With these increasing numbers and types of access nodes deployed within wireless networks, network operators are using carrier aggregation, which enables wireless devices and access nodes to communicate using a combination of component carriers. Component carriers utilize air-interface resources (such as time-frequency resource blocks) spanning different sets of frequencies within one or more frequency bands available to use within a wireless sector. For example, intra-band carrier aggregation involves two or more component carriers using the same or contiguous frequency bands, and inter-band carrier aggregation involves component carriers using different frequency bands that may be separated by a gap. Wireless devices that are capable of inter-band carrier aggregation can receive and send data streams using component carriers in different frequency bands. Further, access nodes can be configured to deploy a frequency-division-duplexing (FDD) carrier and a time-division-duplexing (TDD) carrier, and schedule data transmissions via both carriers using either intra-band or inter-band carrier aggregation. Thus, wireless devices that are capable of carrier aggregation and TDD and FDD communication can send and receive data streams using any combination of different TDD and FDD carriers.

Further, with the evolution of 5G, mm-wave, and sub-6G, increasing numbers of antennae can be used to form beams or perform multiple-in multiple-out (MIMO) operating modes, including single-user (SU-MIMO) and/or a multi-user (MU-MIMO) mode. With massive MIMO or large-scale MIMO, an access node may utilize hundreds of antennae to simultaneously transmit each of a plurality of different data streams to a corresponding plurality of wireless devices. Further, wireless devices may have multiple antennas configured to utilize different RATs and/or to operate as a receive antenna to receive signals from the access node or as a transmit antenna to transmit signals to the access node.

Sounding reference signals (SRS) are transmitted by antennas of wireless devices or user equipment (UE) on the uplink and allow the network to estimate the quality of the channel at different frequencies. For example, the UEs transmit an SRS to an access node (e.g. evolved NodeB (eNB) or next generation NodeB (gNB)) and the access node estimates uplink channel quality in response. Upon receiving the SRS from the UE, the access node measures and analyzes the received signal. It estimates the channel state information (CSI) by comparing the received SRS with a known reference signal. The access node evaluates various parameters, such as the path loss, propagation delay (phase delay), and received signal strength, to understand the current radio environment and channel conditions between the access node and the wireless device. Once the access node has estimated the channel state based on the SRS, it uses this information to optimize its resource allocation and scheduling decisions. These decisions can involve adjusting transmission parameters (such as modulation and coding schemes) or selecting the most appropriate MIMO settings to enhance the overall system capacity and improve the user experience. Often, the SRS is used for an access node to determine appropriate MIMO/precoding for downlink in time division duplexing (TDD). Since the channel property for downlink and uplink is same (channel reciprocity) in TDD, the channel estimation result for uplink based on SRS can be utilized for optimizing downlink process. By leveraging the SRS, the access node can adapt to the dynamic nature of the radio environment and provide more efficient and reliable communication services.

SRS transmission may include antenna switching, also known as reciprocity-based downlink MIMO, which allows transmission of the SRS from receive antennas of the wireless device. Because the number of receive antennas of a wireless device is typically larger than the number of transmit antennas, SRS antenna switching provides for more efficient channel quality estimation by the access node. If a wireless device supports antenna switching, it will report its antenna switching capability to the access node using a user equipment (UE) capability information message.

However, in some particular network environments, particular antenna switching configurations can lead to increased block error rate (BLER) and degradation of downlink throughput, particularly when implementing carrier aggregation utilizing FDD and TDD. Accordingly, a solution is needed for addressing these situations.

### Overview

Exemplary embodiments described herein include methods, systems, and computer readable mediums for optimizing an antenna configuration for sounding reference signals (SRS). An exemplary method for optimizing the SRS antenna configuration includes receiving, at a user equipment (UE) capable of carrier aggregation (CA) and configured with an original antenna configuration, a user equipment (UE) capability enquiry from a radio access network (RAN). The method further includes sending from the UE to the RAN, in response to the UE capability enquiry, a UE capability information message. The UE capability information message indicates a capability to use an optimized SRS antenna switching configuration differing from the original antenna configuration during CA. In embodiments set forth herein, CA involves using time division duplexing (TDD) on a primary cell or primary component carrier and frequency division duplexing (FDD) on a secondary cell or secondary component carrier.

In a further embodiment, an exemplary wireless device is provided. The wireless device includes multiple antennas having an original antenna configuration. The wireless device additionally includes a memory storing instructions and a processor executing the stored instructions. When executing the stored instructions, the processor causes the wireless device to receive a user equipment (UE) capability enquiry and send a UE capability information message in response to the enquiry. The UE capability information message indicates a capability to use an optimized SRS antenna switching configuration during CA, the optimized configuration differing from the original antenna configuration during CA.

A further exemplary embodiment includes a non-transitory computer-readable medium storing instructions executed by a processor. Upon execution, the processor causes multiple steps to be performed. The steps include receiving a user equipment (UE) capability enquiry directed to a UE having an original antenna configuration and capable of CA and generating, in response to the UE capability enquiry, a UE capability information message, the UE capability information message indicating a capability to use an optimized SRS antenna switching configuration during CA differing from the original antenna switching configuration.

### BRIEF DESCRIPTION OF THE DRAWINGS

FIG. 1 depicts an exemplary system for operation of a wireless device in accordance with an embodiment.

FIG. 2 depicts an exemplary access node in accordance with an embodiment.

FIG. 3 depicts an exemplary wireless device in accordance with an embodiment.

FIG. 4 depicts an exemplary case study showing selection of an optimal SRS antenna switching configuration.

FIG. 5 depicts an exemplary method for optimizing an SRS antenna switching configuration.

FIG. 6 depicts an additional exemplary embodiment for implementing an optimized SRS antenna switching configuration.

### DETAILED DESCRIPTION

In embodiments disclosed herein, a sounding reference signal (SRS) antenna configuration for a wireless device is optimized in a network environment implementing CA. More specifically, a network environment may involve a TDD and an FDD duplexing spectrum usage technique. Further, the environment may implement one or more RATS, such as a 5G NR RAT. With FDD/TDD carrier aggregation, FDD uses separate frequencies for the uplink and the downlink and TDD executes uplink and downlink transmissions at different times, using a single frequency for both uplink and downlink. In general, FDD is considered better for coverage, while TDD is better for capacity. Thus, coverage and capacity can be improved by combining FDD and TDD.

While not all wireless devices are capable of CA, many have this capability. Devices capable of CA may have multiple receive (Rx) antenna ports. Each Rx antenna port may correspond to a different communication channel. Thus, the channel conditions for one Rx antenna port may be different than the channel conditions for another Rx antenna port. With SRS antenna switching, a wireless device may be configured to transmit a sounding reference signal (SRS) on each of its Rx antenna ports to measure the channel conditions associated therewith. A variety of antenna port configurations exist and most wireless devices have one or two transmit (Tx) antennas and two to four Rx antennas.

CA-capable wireless devices may share antennas across several bands. For example, antennas may be shared across 5G bands including n41, n25 and n66 bands. In this configuration, the wireless device may utilize SRS antenna switching to send the SRS to the gNB, allowing for beam determination at the gNB for downlink MIMO. The SRS antenna switching feature, when configured, transmits SRS reference signals out of the Rx antennas of the wireless device so that the gNB can more effectively determine the best beams for the wireless device for downlink MIMO.

For downlink TDD transmissions, the use of SRS antenna switching by the wireless devices does not create any degradation issues because slots are preassigned for uplink transmission. However, the antenna switching feature can be used with NRCA where TDD is used for a primary cell (Pcell) and FDD is used for one or more of the secondary cells (Scells). If the Scell is using FDD, and the Pcell is TDD, using SRS antenna switching can create a problem with respect to the FDD downlink transmission for the Scell. In the Scell, the gNB sends FDD downlink signals continuously. Thus, when a shared Rx antenna is used to send the SRS in the uplink, the FDD reception of the Rx antenna is punctured. The puncturing of the FDD reception leads to an increased FDD block error rate (BLER), lower FDD downlink modulation coding scheme (MCS), and FDD downlink throughput degradation.

As a specific example, currently, with some existing hardware designs, n25 and n41 bands share the same receive antennas on wireless devices. During SRS antenna switching, the Rx antennas transmit reference signals and the transmit attaches to those Rx antennas just for a brief period to transmit the SRS and then releases it. This enables the gNB to better estimate and select best beams which the wireless devices can use to achieve the best MIMO configuration. Band n41 is in the time domain and therefore has a time slot for transmitting the SRS over these Rx antennas. However, when band 41 is aggregated with band 25, which is an FDD band, the SRS transmissions puncture the n25 FTD reception while transmitting these SRS back to the gNB. Thus, the n25 SCell is forced to retransmit due to the momentary interruption. The necessity for retransmitting increases the FDD BLER, decreases FDD throughput, and lowers FDD downlink MCS.

Accordingly, embodiments set forth herein optimize an SRS antenna switching configuration for use in a TDD/FDD NRCA environment to minimize FDD BLER and FDD throughput degradation. Specifically, when considering slot cycle spacing and periodicity, an SRS antenna switching configuration is selected that will minimize the puncturing of or interference with the FDD downlink signal to the Rx antennas. In order to implement the selected SRS antenna switching configuration, the access node transmits a UE capability enquiry to the wireless device. In response, the wireless device sends a UE capability information message to the access node providing the selected optimized SRS antenna switching configuration as a UE capability, regardless of the actual capability or original antenna configuration of the UE. For example, while the UE may be able to utilize one Tx and four Rx antennas (1T4R), it will signal its capability as being one Tx and two Rx antennas (1T2R) if 1T2R is the optimal SRS antenna switching configuration based on network parameters such as slot cycle spacing and periodicity.

Thus, in embodiments set forth herein, exemplary wireless devices are simultaneously connecting to a PCell of the RAN using TDD and connecting to an Scell of the RAN using FDD. For these wireless devices, systems and methods provided herein optimize the SRS antenna switching configuration based on slot cycle spacing and periodicity. For example, for an original SRS antenna switching configuration of 1T4R, an optimized SRS antenna switching configuration may be configured as 1T2R based on a 40 ms 80 slot periodicity or a 20 ms 40 slot periodicity and a 30 kHz slot cycle spacing. Thus the optimized configuration utilizes fewer antennas than the original configuration. Once configured, the wireless device transmits a sounding reference signal (SRS) from its receive antennas to an access node of the RAN. The receive antennas may be shared over multiple frequency bands. The multiple frequency bands may include, for example n41, n25, and n66 bands, which may be utilized during new radio carrier aggregation (NRCA). This method and wireless devices capable of performing the method minimize interference with FDD downlink signals that occurs due to SRS antenna switching. Thus, FDD BLER and FDD throughput degradation are also minimized.

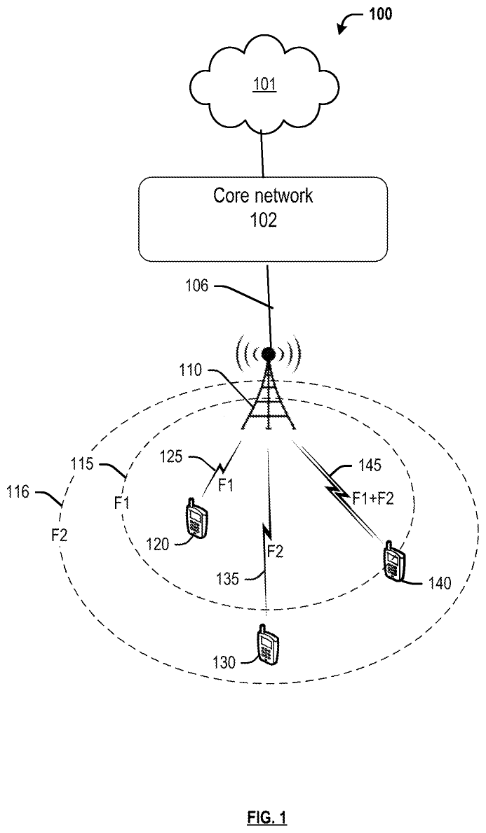

FIG. 1 depicts an exemplary system 100 for utilizing CA in a wireless network. When CA is enabled, wireless devices that are capable of CA can use both carriers, in particular using one carrier as a primary component carrier while one or more additional carriers can be used as secondary carriers. In some embodiments, the primary carrier may be for uplink transmissions and the secondary carrier may be used for downlink transmissions. However, in other embodiments, one or both carriers may be utilized for both downlink and downlink transmission.

System 100 comprises a communication network 101, core network 102, and a radio access network (RAN) including at least an access node 110. Wireless devices 120, 130, and 140 communicate with the access node 110. Furthermore, components not shown may include, for example, gateway node(s) controller nodes, and additional access nodes.

Access node 110 can be any network node configured to provide communication between end-user wireless devices 120, 130, 140 and communication network 101, including standard access nodes and/or short range, low power, small access nodes. For instance, access node 110 may include any standard access node, such as a macrocell access node, base transceiver station, a radio base station, an eNodeB device, an enhanced eNodeB device, a next generation NodeB device (gNBs) in 5G networks, or the like. In other embodiments, access node 110 can be a small access node including a microcell access node, a picocell access node, a femtocell access node, or the like such as a home NodeB or a home eNodeB device. Moreover, it is noted that while access node 110 and wireless devices 120, 130, 140 are illustrated in FIG. 1, any number of access nodes and wireless devices can be implemented within system 100.

As further described herein, by utilizing antennas, access node 110 can deploy a wireless air interface using two or more frequency bands, including but not limited to a first frequency band F1 over a coverage area 115, and a second frequency band F2 over a coverage area 116. In an exemplary embodiment, frequency band F1 uses frequencies that are higher than frequency band F2. Thus, due to propagation characteristics, coverage area 115 is smaller than coverage area 116. Further, the different sets of antennas can be used to implement various transmission modes or operating modes in each sector, including but not limited to MIMO (including SU-MIMO, MU-MIMO, mMIMO, beamforming, etc.), carrier aggregation (including inter-band and intra-band carrier aggregation), and different duplexing modes including FDD and TDD.

For example, as illustrated herein, some of the antennas of access node 110 can be allocated towards deploying a first carrier using frequency F1, to which wireless device 120 attaches using wireless connection 125. Other antennas of access node 110 can be allocated towards deploying a second carrier using frequency F2, to which wireless device 130 attaches using wireless connection 135. Additionally, multiple access nodes may be provided, each deploying multiple antennas. Further, wireless device 140, at an edge of coverage area 115, can be configured to send and receive data via wireless connection 145, which includes resources from both carriers F1 and F2. Further, the first carrier using frequency F1 can be configured to utilize either FDD or TDD modes of operation, and the second carrier using frequency F2 can be configured to utilize a different mode of operation than the first carrier.

Thus, in an exemplary embodiment, wireless device 140 is capable of carrier aggregation using the second carrier F2 as a primary component carrier and the first carrier F1 as a secondary component carrier. Thus, access node 110 can be said to deploy a PCell corresponding to F2 and an SCell corresponding to F1. In an embodiment specifically described herein, TDD mode is used for F2 and FDD mode is used for F1. F2 may for example utilize n41 band and F1 may utilize n25. Other combinations of CA and duplexing modes can be envisioned by those having ordinary skill in the art in light of this disclosure, and dependent on the specific network in which the disclosed embodiments are implemented. For example, wireless device 120 may not be capable of inter-band carrier aggregation, yet may be able to perform intra-band carrier aggregation, utilizing two carriers deployed in frequency F1 or an immediately contiguous frequency band.

Further, access node 110 may be configured to execute methods including sending a UE capability enquiry to wireless device to determine the capabilities of the wireless devices based on a UE capability information message returned from the wireless devices. Further, the access node 110 may receive SRS from the wireless devices and may determine an appropriate beam configuration for downlink MIMO based on the received SRS.

Further, the access node 110 is able to ascertain SRS antenna switching capabilities of each wireless device based on the UE capability information message sent from each wireless device 120, 130, 140 to the access node 110. The UE capability information message may include further characteristics of the wireless device 120, 130, 140. For example, an international mobile subscriber identity (IMSI), model number, etc. may be apparent to access node 110, controller node 104, etc. during, for example, an attach procedure during which each wireless device 120, 130, 140 transmits device capabilities. Based on the identifier, a capability of the wireless device to perform CA can be determined.

Access node 110 can comprise a processor and associated circuitry to execute or direct the execution of computer-readable instructions to perform operations such as those further described herein. Briefly, access node 110 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Further, access node 110 can receive instructions and other input at a user interface. Access node 110 is capable of communicating with the core network 102 as well as various additional nodes including gateway nodes, controller nodes, and other access nodes. The access node 110 may communicate with other access nodes (not shown) using a direct link such as an X2 link or similar.

Wireless devices 120, 130, 140 may be any device, system, combination of devices, or other such communication platform capable of communicating wirelessly with access node 110 using one or more frequency bands deployed therefrom. Wireless devices 120, 130, 140 may be, for example, a mobile phone, a wireless phone, a wireless modem, a personal digital assistant (PDA), a voice over internet protocol (VOIP) phone, a voice over packet (VOP) phone, or a soft phone, as well as other types of devices or systems that can exchange audio or data via access node 110. Other types of communication platforms are possible. Moreover, wireless device 140 can also be equipped with antennas enabling the different types of transmissions as set forth above. For example, wireless device 140 can simultaneously communicate with access node 110 using a first antenna or set of antennas for transmission 115 and a second combination of antennas for transmission 116. Further, it is noted that while access node 110 wireless device 140 are illustrated in FIG. 1, any number of access nodes and wireless devices can be implemented.

Subsequent to sending the UE capability information message reflective of the individual UE capabilities, the wireless devices 120, 130, 140 may receive instructions from the access node 110. For example, Instructing the wireless device 140 to utilize the different antenna configurations can include transmitting an indication from the access node 110 to the wireless device 140. The indication may be an information element sent via radio resource control (RRC) message, in a system information block (SIB) message, or any equivalent means for indicating to the wireless device 140 to activate or utilize the antenna combination(s) correlated with the transmission type of transmissions 115, 116. The instruction can be sent responsive to receiving the service request, or periodically throughout a communication session.

The core network 102 includes core network functions and elements. The core network may have an evolved packet core (EPC) structure or may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QOS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120, 130, 140 and is responsible for handling connection and mobility management tasks. The SMF is primarily responsible for creating updating and removing sessions and managing session context. The UDM function provides services to other core functions, such as the AMF, SMF, and NEF. The UDM function may function as a stateful message store, holding information in local memory. The NSSF can be used by the AMF to assist with the selection of network slice instances that will serve a particular device. Further, the NEF provides a mechanism for securely exposing services and features of the core network.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 120, 130, 140, etc. Wireless network protocols can comprise MBMS, code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication link 106 can use various communication media, such as air, space, metal, optical fiber, or some other signal propagation path-including combinations thereof. Communication link 106 can be wired or wireless and use various communication protocols such as Internet, Internet protocol (IP), local-area network (LAN), optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Communications links 106 may include S1 communications links. Other wireless protocols can also be used. Communication link 106 can be a direct link or might include various equipment, intermediate components, systems, and networks. Communication links 106 may comprise many different signals sharing the same link.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication system 100 may be, comprise, or include computers systems and/or processing nodes. This includes, but is not limited to access node 110, controller node 104, and/or network 101.

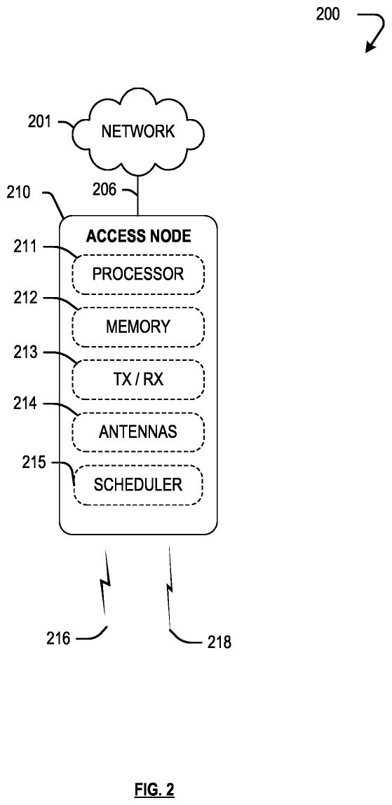

FIG. 2 depicts an exemplary access node 210. Access node 210 is configured as an access point for providing network services from network 201 to end-user wireless devices such as wireless devices 120, 130, 140 in FIG. 1. Access node 210 is illustrated as comprising a memory 212 for storing logical modules that perform operations described herein, a processor 211 for executing the logical modules, and a transceiver 213 for transmitting and receiving signals via antennas 214. Combinations of antennas 214 and transceivers 213 are configured to deploy a wireless air interface using at least two carriers, each of which uses a different frequency band. Further, the different sets of antennas can be used to implement various transmission modes or operating modes in each sector, including but not limited to MIMO (including SU-MIMO, MU-MIMO, mMIMO, beamforming, etc.), CA, and different duplexing modes including FDD and TDD. Further, access node 210 is communicatively coupled to network 201 via communication interface 206, which may be any wired or wireless link as described above. Scheduler 215 may be provided for scheduling resources based on the presence and performance parameters of the UEs 120, 130, 140.

In an exemplary embodiment, memory 212 includes logic for sending capability enquiries and receiving and processing UE capability information messages. In another exemplary embodiment, memory 212 includes logic for responding to UE capability information messages by configuring communication with the wireless device to correspond to wireless device capabilities. For example, the access node 210 disables and enables carrier aggregation depending on the capabilities of the wireless device. Wireless communication links 216 and 218 may deploy different duplexing modes including TDD and FDD.

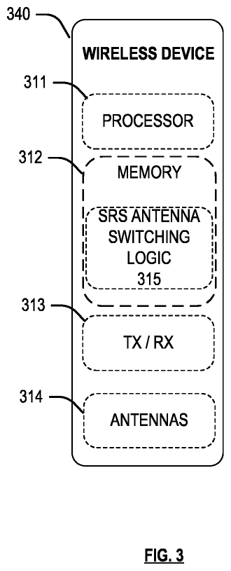

FIG. 3 depicts an exemplary wireless device 340 for transmitting an optimized SRS antenna switching configuration based on network characteristics. For example, the wireless device 340 transmits an optimal SRS antenna switching configuration for the wireless device 340 based on network characteristics such as slot cycle spacing and periodicity. Wireless device 340 may be any device, system, combination of devices, or other such communication platform capable of communicating wirelessly with an access node, such as access node 210, 110 or other network nodes using one or more frequency bands deployed therefrom. Wireless device 340 may be, for example, a mobile phone, a wireless phone, a wireless modem, a personal digital assistant (PDA), a voice over internet protocol (VOIP) phone, a voice over packet (VOP) phone, or a soft phone, as well as other types of devices or systems that can exchange audio or data via access nodes. Other types of communication platforms are possible. Wireless device 340 is illustrated as comprising a processor 311, a memory 312 for storing logical modules that perform operations described herein, and one or more transceivers 313 for transmitting and receiving signals via antennas 314. As will be further described below, a combination of Tx and Rx antennas 314 may be utilized. Commonly used antenna configurations include 1T2R, 1T4R, and 2T4R.

Combinations of antennas 314 and transceivers 313 are configured to access and communicate via one or more radio air interfaces using different duplexing modes, RATs, and frequencies. For example, transceivers and antennae can be configured to communicate using 4G, 5G, mm-wave, MU-MIMO or massive MU-MIMO, as well as to facilitate communication with other network nodes and wireless devices via, for example, Wi-Fi, BLUETOOTH, NFC, etc.

In an exemplary embodiment, memory 312 stores SRS antenna switching logic 315. The SRS antenna switching logic 315 may include optimized SRS antenna switching configurations for various network conditions. For example, the SRS antenna switching logic may include a table of optimized SRS antenna switching configurations for an NRCA network utilizing TDD for a Pcell and FDD for one or more Scells. A selected optimized SRS antenna switching configuration may, for example, be based on network settings for slot cycle spacing 30 kHz and periodicity of 40 ms (40 slot). In this instance, for an original antenna configuration of 1T4R, an optimized SRS antenna switching capability of 1T2R may be selected. As will be further described below, the optimized SRS antenna switching capability causes less interference to the FDD downlink signals than the original antenna configuration and therefore lowers FDD BLER. Accordingly, in response to a UE capability enquiry with the above-described network settings, the SRS antenna switching logic will cause an optimized SRS antenna switching configuration of 1T2R to be sent to the access node as an information element in a responsive UE capability information message. Thus, the SRS antenna switching logic 315 can cause the wireless device 340 to utilize a reduced number of antennas for SRS antenna switching in order to optimize FDD reception.

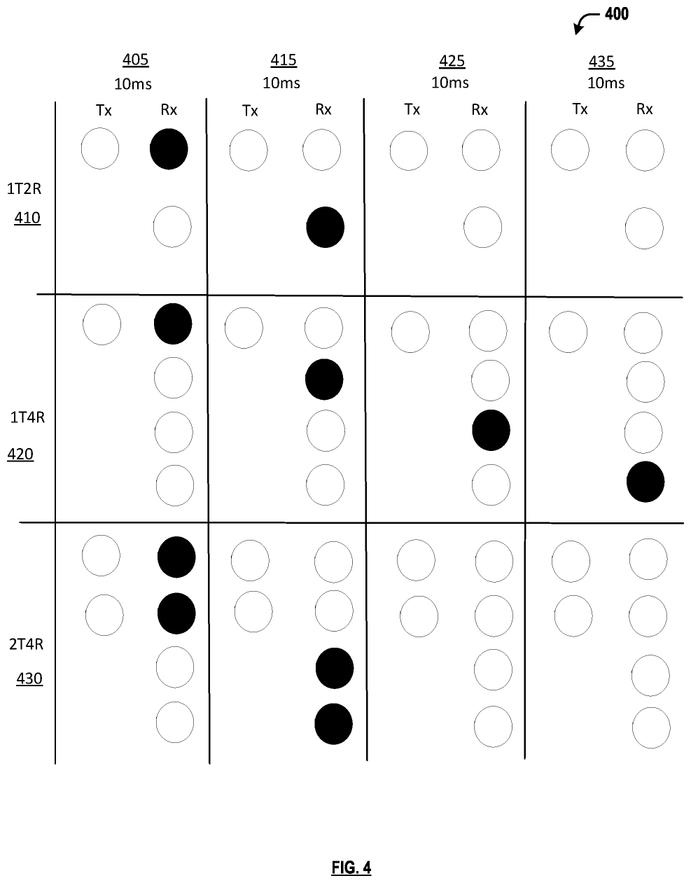

FIG. 4 illustrates an SRS antenna switching scenario 400 in accordance with embodiments set forth herein. Common antenna configurations are shown at 410, 420, and 430. Specifically, common antenna configurations include 1T2R, 1T4R and 2T4R. Further the scenario 400 assumes the network is utilizing FDD/TDD NRCA. Transmission and reception for each antenna configuration is shown during 10 ms increments 405, 415, 425, and 435. The 10 ms increments occur within an SRS reporting periodicity of 40 ms or 80 slots at 30 KHz subcarrier spacing. Similarly, 5 ms increments could be utilized for 20 ms periodicity or 40 slots at 30 KHZ subcarrier spacing. The filled ovals in the diagram represent the puncturing of FDD reception for an Rx antenna.

Thus, in the 1T2R configuration shown at 410, puncturing of FDD reception at an Rx antenna occurs twice in the first 20 milliseconds while the Rx antenna is transmitting, but does not occur over the next 20 milliseconds. Specifically, the reception of the first Rx antenna is punctured in the first 10 ms and reception of the second Rx antenna is punctured in the next 10 ms. For the next 20 ms, the reception of the Rx antennas is not punctured.

For the 1T4R configuration shown at 420, reception of an Rx antenna is punctured during each 10 ms increment. Reception of the first Rx antenna is punctured in the first 10 ms at 405, reception of the second Rx antenna is punctured in the second 10 ms at 415, reception of the third Rx antenna is punctured in the next 10 ms at 425 and reception of the fourth Rx antenna is punctured in the next 10 ms at 435. Thus, in the 1T4R configuration, no significant gaps exist during which reception of an Rx antenna is not punctured. The reception is punctured every 10 ms. This results in an increase in FDD cell BLER as the missed transmissions must be sent again. Similarly, in a scenario with 20 ms periodicity, the 1T4R device punctures the FDD SCell reception four times (every 5 ms over 20 ms).

For the 2T4R configuration at 430, the reception of the first two Rx antennas is punctured twice during the first 10 ms increment and twice during the second 10 ms increment. However, reception is not punctured during the subsequent 20 ms. Thus, a 20 ms gap exists during which reception of the Rx antennas is not punctured.

Accordingly, the 1T4R configuration experiences FDD BLER and degradation nearly constantly with the network parameters in scenario 400. In contrast, the 1T2R and 2T4R configurations experience large gaps during which the reception of the Rx antennas is not punctured. Accordingly, these configurations can be considered to be optimized for SRS antenna switching given the network parameters. Since it is possible for a 1T4R configuration to operate as a 1T2R configuration for antenna switching, embodiments set forth herein equip wireless devices with 1T4R configurations with the logic to present themselves to the network as 1T2R configurations for the purpose of antenna switching during NRCA. This will mitigate FDD Scell BLER and 1T4R devices will be able to operate as efficiently as 1T2R and 2T4R devices. Further, the optimization of the SRS antenna switching configuration will also help the FDD secondary component carrier in lowering the hybrid automatic repeat request (HARQ) retransmissions needed due to the additional BLER. Thus, optimization may be based on minimizing the number of intervals during which FDD reception is punctured by the SRS transmissions from the Rx antennas.

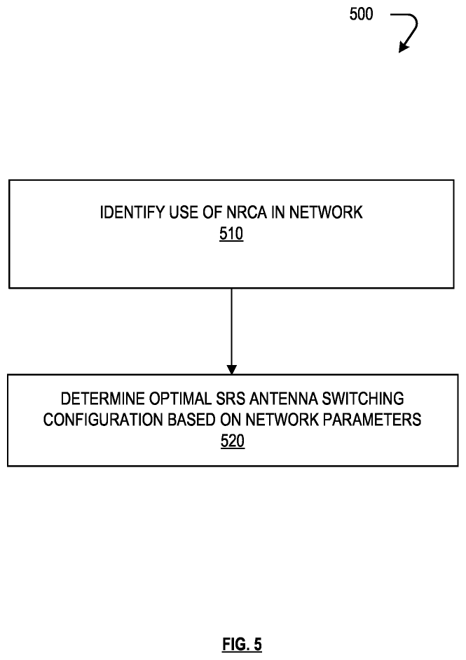

FIG. 5 depicts an exemplary method 500 for selecting an optimized SRS antenna switching configuration for a wireless device. The method of FIG. 5 is illustrated with respect to an access node, such as access node 110, 210. In other embodiments, the method can be implemented with any suitable network element, such as a processing node, a processor of a wireless device, or a core network element having a processor. Although FIG. 5 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

At 510, the use of NRCA is identified in the network. More particularly, the use of NRCA may be identified between multiple wireless devices and an access node. Specifically, the use of TDD and FDD may be identified, where FDD is utilized in the downlink, so that transmission of the SRS from Rx antennas of the wireless device would have the potential to puncture FDD reception on the Rx antennas of the wireless device.

In step 520, the processor of the access node 110 or processing node determines one or more optimal SRS antenna switching configurations based on network parameters. With reference to FIG. 4, the determination of optimal SRS antenna switching configurations can be based made based on the largest periods of unpunctured FDD reception during transmission from the receive antennas. The evaluation requires knowledge of such factors as slot cycle spacing and periodicity. Based on the evaluation, one or more optimal SRS antenna switching configurations can be selected. For example, an optimized antenna configuration can be selected that uses fewer antennas than the original antenna switching configuration.

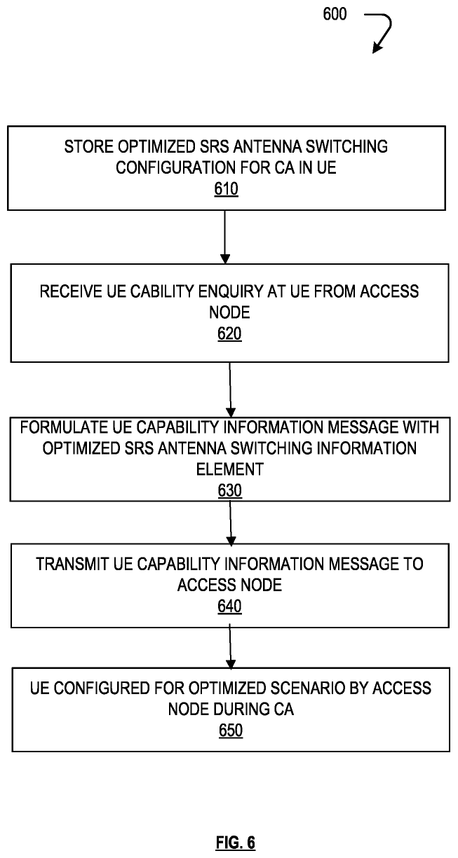

FIG. 6 depicts an exemplary method performed by a wireless device for optimizing an SRS antenna switching configuration. The method of FIG. 6 is illustrated with respect to a wireless device, such as wireless device 140, 340 and may be performed when the processor 311 executes the SRS antenna switching logic 315. Although FIG. 6 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

At 610, the wireless device 340 stores an optimized SRS antenna switching configuration for NRCA using TDD and FDD in the memory 312. The optimized SRS antenna switching configuration may be obtained from a network component, such as an access node, processing node, or the core network through a message sent to the wireless device. Alternatively, the optimized SRS antenna switching configuration may be determined by a network operator and may be stored on the wireless device prior to distribution of the wireless device to an end user. As a further example, the SRS antenna switching logic 315 may determine the optimized antenna switching configuration based on characteristics of the network. The optimized antenna switching configuration or capability may be determined as explained above with respect to FIG. 4 based on network parameters. In embodiments set forth herein, the optimized SRS antenna switching configuration utilizes fewer antennas than the original antenna configuration of the wireless device.

In step 620, the wireless device 340 receives a UE capability enquiry from an access node 110, 210. In response, in step 630, the wireless device 140, 340 formulates a UE capability information message with the optimized SRS antenna switching configuration for NRCA as an information element. In embodiments set forth herein, the wireless device 140, 340 has an original antenna configuration of 1T4R, but adds an optimized SRS antenna switching capability of 1T2R as an information element in the UE capability information message.

In step 640, the wireless device 140, 340 transmits the UE capability information message to the access node. Ultimately, the access node 210, which may for example be a gNB, transmits to the wireless device 140, 340 during NRCA based on the received optimized SRS antenna switching configuration received with the UE capability information message and instructs the wireless device to utilize the appropriate antenna configuration, for example, by transmitting an indication to the wireless device from the access node. The indication may be an information element sent via radio resource control (RRC) message, in a system information block (SIB) message, or any equivalent means for indicating to the wireless device to utilize antennas. Thus, a gNB may configure a 1T4R wireless device for 1T2R during NRCA when the 1T2R configuration is sent as an information element in the UE capability information message.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
receiving, at a user equipment (UE) capable of carrier aggregation (CA) and configured with an original antenna configuration, a user equipment (UE) capability enquiry from a radio access network (RAN); and
sending from the UE to the RAN, in response to the UE capability enquiry, a UE capability information message, the UE capability information message having an information element indicating an optimized SRS antenna switching configuration during CA, wherein the optimized SRS antenna switching configuration is different from the original SRS antenna switching configuration.

2. The method of claim 1, further comprising simultaneously connecting to a primary cell (PCell) of the RAN using time domain duplexing (TDD) and connecting to a secondary cell (SCell) of the RAN using frequency domain duplexing (FDD).

3. The method of claim 2, further comprising optimizing the SRS antenna switching configuration based on slot cycle spacing and periodicity.

4. The method of claim 3, wherein the original SRS antenna switching configuration is 1T4R and the optimized SRS antenna switching configuration is 1T2R.

5. The method of claim 4, further comprising using a 40 ms 80 slot periodicity and a 30 kHz slot cycle spacing.

6. The method of claim 1, further comprising transmitting a sounding reference signal (SRS) from receive antennas of the UE to an access node of the RAN.

7. The method of claim 1, further comprising sharing receive antennas over multiple frequency bands.

8. The method of claim 7, wherein the multiple frequency bands include n41, n25, and n66 bands.

9. The method of claim 1, further comprising utilizing new radio carrier aggregation (NRCA).

10. A wireless device configured for carrier aggregation (CA), the wireless device comprising:
an original antenna configuration including multiple antennas;
a memory storing instructions; and
a processor executing the stored instructions to perform operations including,
receiving at the wireless device capable of CA, a user equipment (UE) capability enquiry; and
sending from the wireless device, in response to the UE capability enquiry, a UE capability information message, the UE capability information message having an information element indicating an optimized SRS antenna switching configuration, different from the original antenna configuration.

11. The wireless device of claim 10, the operations further comprising simultaneously connecting to a primary cell (PCell) of a RAN using time domain duplexing (TDD) and connecting to a secondary cell (SCell) of the RAN using frequency domain duplexing (FDD).

12. The wireless device of claim 11, the operations further comprising optimizing the SRS antenna switching configuration based on slot cycle spacing and periodicity.

13. The wireless device of claim 12, wherein the original SRS antenna configuration is 1T4R and the optimized SRS antenna switching configuration is 1T2R.

14. The wireless device of claim 13, the operations further comprising using a 20 ms 40 slot periodicity and a 30 kHz slot cycle spacing.

15. The wireless device of claim 10, the operations further comprising transmitting a sounding reference signal (SRS) from receive antennas of the UE to an access node.

16. The wireless device of claim 10, the operations further comprising sharing receive antennas over multiple frequency bands.

17. The wireless device of claim 10, the operations further comprising utilizing new radio carrier aggregation (NRCA).

18. The wireless device of claim 17, wherein the original antenna configuration is 1T4R and the optimized SRS antenna switching configuration during NRCA is 1T2R.

19. A non-transitory computer-readable medium storing instructions that when executed by a processor perform operations comprising:
receiving a user equipment (UE) capability enquiry directed to a UE capable of new radio carrier aggregation (NRCA), the UE having an original antenna configuration; and
generating, in response to the UE capability enquiry, a UE capability information message, the UE capability information message indicating an optimized antenna switching configuration different from the original antenna configuration.

20. The non-transitory computer-readable medium of claim 19, the operations further comprising connecting to a PCell using TDD and connecting to an SCell using FDD.
